(19) United States
(12) Patent Application Publication
(10) Pub. No.: US 2025/0149828 A1
(43) Pub. Date: May 8, 2025

(54) CARD EDGE CONNECTOR WITH AN IMPROVED RELEASING MEMBER

(71) Applicants: FOXCUNN (KUNSHAN) COMPUTER CONNECTOR CO., LTD., Kunshan (CN); FOXCUNN INTERCONNECT TECHNOLOGY LIMITED, Grand Cayman (KY)

(72) Inventors: KUO-CHUN HSU, New Taipei (TW); MING-YI GONG, Huaian (CN); WEN-LUNG HSU, New Taipei (TW); XUN WU, Huaian (CN); PO-FU CHEN, New Taipei (TW)

(21) Appl. No.: 18/931,724

(22) Filed: Oct. 30, 2024

(30) Foreign Application Priority Data
Nov. 7, 2023 (CN) 202311466410.0

(51) Int. Cl. H01R 13/635; H01R 12/73; H01R 13/627

(52) U.S. Cl. CPC H01R 13/635; H01R 12/737; H01R 13/6275

(57) ABSTRACT

A card edge connector includes: a connector body having a card slot and plural terminals arranged on opposite sides of the card slot; a latch mounted at an end of connector body; and a releasing member including a pair of levers disposed at opposite sides of the connector body and a mover, wherein first ends of the levers are connected with the latch, second ends are connected with the mover, and when the card is inserted into the card slot the mover is pushed to move downwards companied with a downward movement of the second ends and an upward movement of the first ends of the levers, the upward movement of the first ends drive the latch to lock with the card and when the card is pulled out the mover is released from a pressure of the card and reset to unlock the latch from the electronic card.

### BACKGROUND OF THE INVENTION

### Field of the Invention

The present invention relates generally to a card edge connector, and particularly to a card edge electrical connector with an improved releasing member.

### Description of Related Arts

Mother boards used in computers, servers and so on, are equipped with many electrical connectors for achieving an expanding function, such as AGP connector, PCI connector, and USB connector. Users can insert cards, such as display cards or internet cards, into the connectors on the mother boards. Since the connectors on the mother boards have a small separating space, it is different for users to release the locked latch on the cards before removing the card by hands or by tools. China Patent No. 102082339B discloses a card edge connector with a connecting member on the latch for users to pull the connecting member to release the latch from the card. U.S. Pat. No. 11,868,187 discloses that a card edge connector is added with a transferring mechanism beside the connector body. Users push on the transferring mechanism which in turn transfers force to the latch to release the latch from the card. Both patents need that one hand of the user operates on the connecting member or the transferring mechanism while the other hand operates on the card.

An improved card edge connector is desired.

### SUMMARY OF THE INVENTION

An object of the present invention is to provide a card edge connector with an improved releasing member.

To achieve the above-mentioned object, a card edge connector adapted for insertion of an electronic card comprises: a connector body having a mating face and a card slot running through the mating face; a plurality of terminals arranged on opposite sides of the card slot; a latch mounted at an end of connector body; and a releasing member comprising a pair of levers disposed at opposite sides of the connector body and a mover, wherein each of the lever has a first end and a second end opposite to the first end, the first ends of the levers are connected with the latch, and the second ends are connected with the mover, and when the electronic card is inserted into the card slot the mover is pushed to move downwards companied with a downward movement of the second ends and an upward movement of the first ends of the levers to drive the latch to lock with the card and when the electronic card is pulled out the mover is released from a pressure of the electronic card and reset to unlock the latch from the electronic card.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a card edge connector mounted on a circuit board, according to an embodiment of the present invention, wherein a latch and a releasing member are in a locking statue;

FIG. 2 is a front view of the card edge connector of FIG. 1, wherein a metal plate is removed and a sketched electrical card is inserted in the connector to show how the releasing member and the latch work;

FIG. 3 is a perspective view of the card edge connector of FIG. 1 without the metal plate, wherein the card edge connector is in an original or opening statue without an insertion of the electronic card;

FIG. 4 is a front view of the card edge connector of FIG. 3;

FIG. 5 is a perspective view of the releasing member and the latch of FIG. 3; and

FIG. 6 is a further exploded perspective view of the releasing member and the latch of FIG. 5.

### DETAILED DESCRIPTION OF THE PREFERRED EMBODIMENT

Reference will now be made to the drawing figures to describe the preferred embodiment of the present invention in detail.

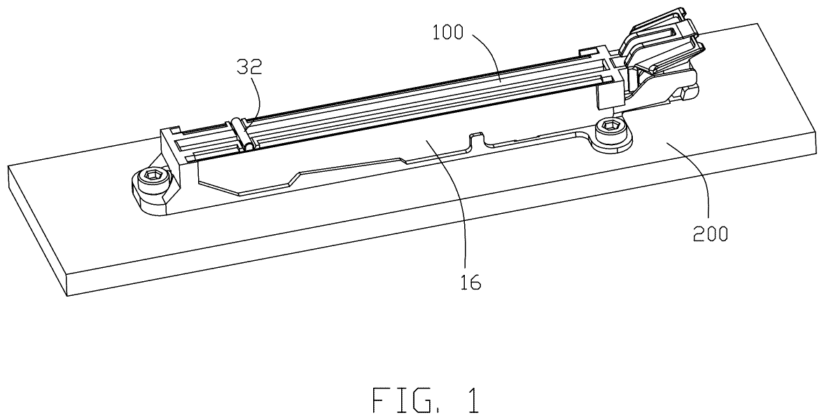

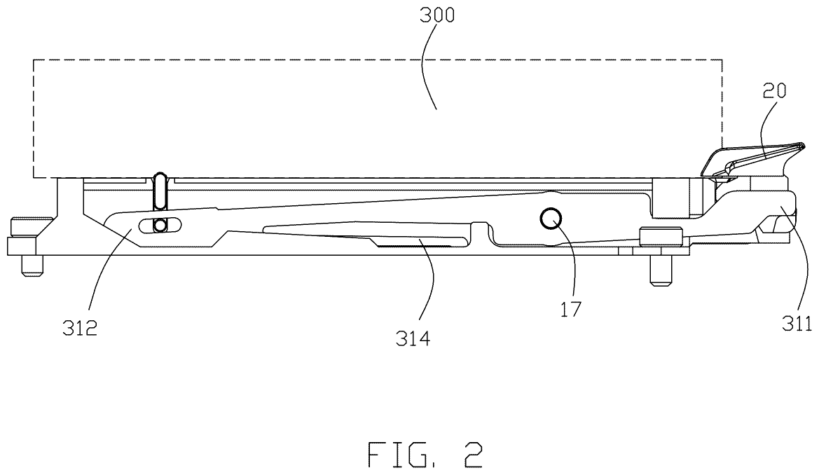

Referring to FIGS. 1-2, a card edge connector 100 of this present invention is mounted on a printed circuit board 200 and is adapted for an insertion of electronic card 300 as shown in FIG. 2 to establish an electrical connection between the card and the board 200. The card 300 is compatible of a PCI Express CEM specification.

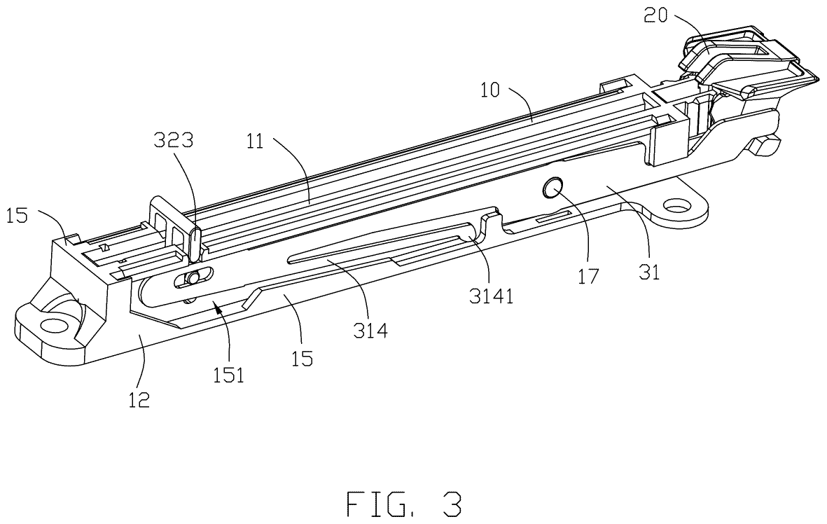

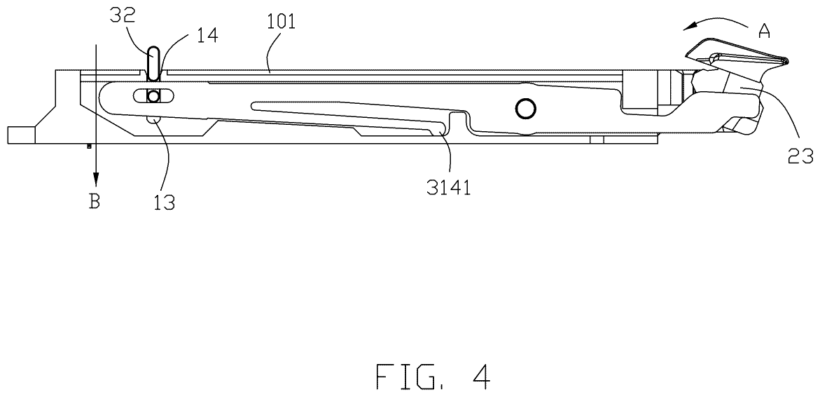

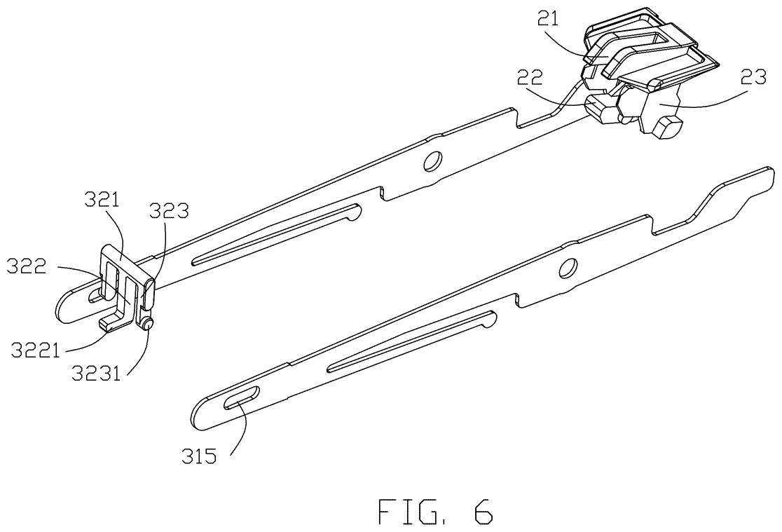

Referring to FIGS. 3-6, the connector 100 includes a connector body 10, a latch 20 mounted on a longitudinal end of the connector body and a releasing member 30. The connector body 10 has a mating face 101, a card slot 11 running through the mating face 101 and two rows of terminals (not shown) located at opposite sides of the card slot 11. The latch 20 is mounted at one end of the connector body, or on the board 200 proximate to the longitudinal end of the connector body 10. The latch 20 is rotated relate to the connector body 10. When the latch 20 rotates towards the connector body 10 as shown in arrow A in FIG. 4, the locking portion 21 of the latch is locked with a notch defined on a side of the card 300, to avoid the card from escaping from the connector body 20. When the latch 20 is rotated outwards by an external force, an ejecting portion 22 on the latch as shown in FIG. 6 pushes the card 300 upwards to accelerate a movement of card from the connector body. The characteristic of this invention is that the releasing member 30 includes a pair of levers 31 and a mover 32, the levers are located at outsides of the card slot 11, and attached to the connector body 10 by a pivot means. First ends 311 of the levers 31 are connected with the latch 20, second ends of the levers are connected with the mover 32. The mover 32 protrudes upwards beyond the mating face 101 as shown in FIG. 4 in an original or opening statue when there is no card inserted. When the card is inserted into the card slot 11, the mover 32 is pushed to move downwards until it arrive in the connector body 10 by the card, the levers 31 are driven to do a lever motion by the downward movement of the mover 32 companied with the rotation of the latch 20 to a locking statute wherein the latch is locked with the notch of the card. When the card is pulled out, the mover 32 reset since the pressure of the card is released, the levers 32 are driven to do a lever motion by an upward force, companied with the rotation of the latch to the opening statue. Understood, the release 30 moves and restores energy at the inserted card. When the card is ready to pull out, the card is slightly pulled out by a user without a rotation of the latch, the release of the stored energy of the releasing member 30 drives the latch 20 to the opening statue, thereby opening the releasing member. In this embodiment, the releasing member 30 has a deformation of a metal plate to store energy.

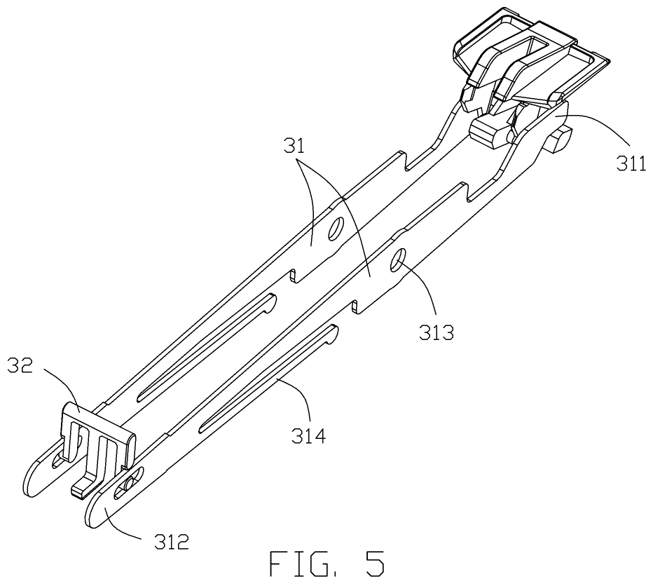

As shown in FIGS. 5-6, the releasing member 30 include the lever 31 and the mover 32. Combined with FIG. 3, the lever is located at the outer side of the card slot, and connected with the connector body 10 by a pivot way, the first end 311 is connected with the latch 20 and the second end 312 opposite to the first end is connected with the move 32. The lever 31 is formed by a metal plate, which is uprightly attached the side of the connector body 10, wherein a pivot hole 313 of the lever is assembled with a pivot axis 17 on the side of the connector body. The pivot hole 313 is located a position between the first end and the second end of the lever so that the lever moves with a lever motion. The latch 20 has a groove 23 at each of opposite sides thereof, the first end 311 of the lever is received in the groove 23. A spring portion 314 unitarily extends from the second end 312 of the lever and slants towards the first end 311, a distal end 3141 of the spring portion is supported and compressed to generate pre-pressure. The spring portions 314 are located between the second ends and the positions of the levers to generate a force applied on the second ends of the levers. This pre-pressure keeps the mover 32 on an upper position, or reset the mover 32 to the upper position. In this embodiment, the spring portion 314 slants from the second end 312 downward to be a spring arm shape, the distal end 3141 is supported on the connector body 10. In other embodiment, the distal end 3141 is designed to run through the connector body and on the board 200. That is, a supporting face is designed nowhere the supporting face is. The mover 32 is made from a plastic material.

Referring to FIGS. 5-6, the mover 32 includes a transverse rod 321 and a first L-shaped arm 322 and a pair of second L-shaped arms 323. The first L-shaped arm is received in the card slot 11 with an ejecting portion 3221 at a distal end thereof. The second L-shaped arm 323 has a shaft 323, the shaft 323 is received in the longitudinal slot 315 defined on the second end of the lever. In this embodiment, the connector body 10 has two sidewalls 12 at opposite sides of the card slot 11, each of the sidewall has a sliding slot 13 extending in an up-and-down direction, the second L-shaped arms 323 moves in the sliding slot 13. The sidewalls have a groove 14 corresponding to the sliding slot 13 to receive the transverse rod 321. The mover straddles the card slot 11 to form an anti-mating key.

In this embodiment, in the original or opening statue that the card 300 does not insert into the card slot of the connector, the mover 32 protrudes upwards beyond the mating face 101, and a bottom of the mover 32 is located above the bottom of the card slot 11. That is, a height space is remained between the mover and the bottom of the card slot, and the mover sit on the bottom of the card slot when the mover 32 moves downwards to keep balance of the mover. Alternatively, the mover can be disposed above the bottom of the mating slot, or the mover can be located a space dug on the bottom of the card slot. Actually, it is better to decrease dig on the bottom of the card slot.

When the card 300 is inserted into the card slot 11, a lower edge of the card push the mover 32 to mover downwards companied with a downward movement of the second end 312 of the lever, an upward movement of the first end 312 of the lever is produced by the lever do a lever motion around the shaft 17, companied with an inward rotation of the latch 20 towards the connector body, thereby achieving the locking statue. During the downward movement of the second end 312 of the lever, the spring portion 314 moves downward but the distal end 3141 of the spring portion 314 is pressed against the connector body, so that the spring portion wholly is compressed to store energy as shown in FIG. 2. When a user wants to pull the card 300 out of the card slot, it is no need to open the latch 20. The user slight pull the card 300 upwards to release the mover 32 from the card, the stored energy of compressed spring portion 314 is released to push the mover 32 to move upwards companied with an upward movement of the second end 312 of the lever. The first end 311 of the lever move downward to bring the latch 20 to rotate outward due to the lever does a lever motion.

The connector body 10 includes a longitudinal insulating housing 15 and terminals. The housing includes the card slot 11 and recessed portions 151 at the outer sides of the sidewalls. The levers are attached in the recessed portions 151. The spring portion 314 extends from the lever proximate to the second end, the spring portion presses against the bottom of the recessed portion 151. Two metal plates 16 cover opposite sidewalls to surround the releasing member 30, thereby get a shielding function and a neat appearance.

The above-mentioned embodiments are only preferred embodiments of the present invention, and should not limit the scope of the present invention, any simple equivalent changes and modifications made according to the claims of the present invention and the contents of the description should still belong to the present invention.

1. A card edge connector adapted for insertion of an electronic card, comprising:
a connector body having a mating face and a card slot running through the mating face;
a plurality of terminals arranged on opposite sides of the card slot;
a latch mounted at an end of connector body; and
a releasing member comprising a pair of levers disposed at opposite sides of the connector body and a mover;
wherein each of the lever has a first end and a second end opposite to the first end, the first ends of the levers are connected with the latch, and the second ends are connected with the mover; and
when the electronic card is inserted into the card slot the mover is pushed to move downwards companied with a downward movement of the second ends and an upward movement of the first ends of the levers to drive the latch to lock with the card and when the electronic card is pulled out the mover is released from a pressure of the electronic card and reset to unlock the latch from the electronic card.

2. The card edge connector as claimed in claim 1, wherein the lever is made from a metal plate, and the levers deform to store energy after the electronic card is inserted in the card slot while the levers release the stored energy to push the mover to reset when the mover is released from the pressure of the electronic card on the mover.

3. The card edge connector as claimed in claim 1, wherein the lever is made from a metal plate and comprises a unitarily extending spring portion, the spring portion deforms to store energy when the electronic card is inserted into the card slot.

4. The card edge connector as claimed in claim 3, wherein the spring portion slants downward from the second end of the lever, and a distal end of the spring portion is supported on the connector body or on a board on which the card edge connector is mounted.

5. The card edge connector as claimed in claim 1, wherein the mover comprises a transverse rod and a first L-shaped arm and a pair of second L-shape arms extending downwards from the transverse rod, the first L-shaped arm is received in the card slot and has an ejecting portion, and each of the second L-shaped arms has a shaft engaged with a longitudinal slot defined on the second end of the lever.

6. The card edge connector as claimed in claim 5, wherein the connector body comprises two sidewalls located at opposite sides of the card slot, the sidewalls have a sliding slot extending in an up-and-down direction, and the second L-shape arms slide in the sliding slot.

7. The card edge connector as claimed in claim 6, wherein the sidewalls define a groove recessed from the mating face and the transverse rod is received in the groove.

8. The card edge connector as claimed in claim 1, wherein the connector body comprises two sidewalls located at opposite sides of the card slot, the mover straddle the sidewalls to construct an anti-mating key.

9. The card edge connector as claimed in claim 1, further comprising two metal plates attached to the connector body to surround the releasing member.

10. A card edge connector comprising:
a connector body having a mating face and a card slot running through the mating face;
a latch mounted around a first end of connector body;
a releasing member comprising a lever at a side of the card slot and a mover across the card slot; and
a spring portion extending from the lever;
wherein the lever is pivotally connected with the connector body at a position between a first end and a second end opposite to the first end, the first end of the lever is connected with the latch and the second end of the lever is connected with the mover, the spring portion is located between the second end and the position, and the spring portion keeps the second end with the mover in an upper position that the mover protrudes upwards beyond the mating face and pushes the latch away from the connector body.

11. The card edge connector as claimed in claim 10, wherein the spring portion slants downward and presses against the connector body or a board on which the connector body is mounted.

12. The card edge connector as claimed in claim 10, wherein the mover has a shaft slidably received in a longitudinal slot defined on the second end of the lever.

13. The card edge connector as claimed in claim 12, wherein a pivot hole is defined on the lever to engage with a pivot shaft defined on the side of the connector body.

14. The card edge connector as claimed in claim 10, wherein the mover has an ejecting portion located in the card slot.

15. A card edge connector comprising:
a connector body having a mating face and a card slot running through the mating face;
a latch mounted at an end of connector body; and
a releasing member comprising a pair of levers attached at opposite sides of the connector body and a mover, each of the levers having a first end and a second end opposite to the first end;
wherein each of the lever has a pivot hole between the first end and the second end and a spring portion extending therefrom and located between the second end and the pivot hole, the pivot hole is engaged with a pivot shaft defined on the connector body, the first ends of the levers are connected with the latch and the second ends of the levers are connected with the latch, and the spring portion is compressed to keep the second end with the mover protruding upwards.

16. The card edge connector as claimed in claim 15, wherein the mover has a transverse rod and a pair of second L-shaped arms with a shaft, and the shaft is received and slides in a longitudinal slot defined on the second end of each of the levers.

17. The card edge connector as claimed in claim 16, wherein the mover has a first L-shaped arm with an ejecting portion, and the ejecting portion is located in the card slot.

18. The card edge connector as claimed in claim 17, wherein the lever is made from a metal plate, and the spring portion unitarily slants.
